(19) United States
(12) Patent Application Publication
(10) Pub. No.: US 2026/0186936 A1
(43) Pub. Date: Jul. 2, 2026

(54) GRANULAR TRACKING OF TENANT RESOURCE USAGE IN A MULTI-TENANT PLATFORM ARCHITECTURE

(71) Applicant: Pegasystems Inc., Waltham, MA (US)

(72) Inventors: Praneeth Talishetti, Hyderabad (IN); Pratik Talishetti, Hyderabad (IN); Tetali Sri Venkata Krishna Surya Satyanarayana Murthy, Hyderabad (IN)

(21) Appl. No.: 19/001,771

(22) Filed: Dec. 26, 2024

(51) Int. Cl. G06F 11/30; G06F 9/50

(52) U.S. Cl. CPC G06F 11/3006; G06F 9/5072; G06F 9/5077

(57) ABSTRACT

A system and method are disclosed to track the resource usage of individual tenants in a multitenant platform. The tracking may be performed at a granular request level. In some implementations, fingerprints are used to determine the resource usage of individual service requests. A variety of different use cases can be supported, such as enhanced load balancing.

### TECHNICAL FIELD

The present application is generally related to tracking resource usage in a multi-tenant platform architecture.

### BACKGROUND

The multi-tenant architecture is increasingly popular in cloud computing and software-as-a-service (SaaS) applications. A multi-tenant system is a software application or system that serves multiple customers (tenants) with distinct data and configuration settings. The multi-tenant architecture allows applications to share resources among different users. In a multi-tenant architecture, multiple user groups (tenants) have access to an instance of an application or a system.

However, there are a variety of problems in a multi-tenant architecture in regard to accurately identifying the resource consumption of individual tenants. Techniques exist to monitor resource usage at a node level but there are a variety of problems in tracking resource usage at a tenant level.

Accurately tracking resource consumption of tenants in a multi-tenant architecture is difficult using conventional approaches. For example, reactive applications, which respond to changes in data instantly, raise various problems for accurately determining resource consumption of tenants. Reactive programming is a programming paradigm that focuses on data streams and the propagation of change.

In the current paradigm, to get accurate tenant level usage tracking, it is necessary to go for technology and programming paradigm specific custom instrumentation. This has high maintenance cost due to: 1) the convolution of application logic and performance measuring algorithms and 2) the variety of technologies and services used in any system.

Also, many tools provide only thread-level performance metrics. But reactive applications do not use a thread-per-request mode. For reactive applications, one must consider request-context and its propagation while developing complex resource consumption calculation methods. Such complex methods often have high maintenance cost. Some of the reasons of this include the fact that in the absence of appropriate tenant usage tracking facilities, use cases like billing are often solved using some kind of high-level usage indicators like amount of data transfer etc. The service provider often must implement multiple mitigation strategies to disallow tenants from exploiting weak indicators. The service consumers often must implement complex and irrational strategies for optimizing their bills. In certain scenarios, a system should enforce usage threshold values to prevent the noisy neighbor problem. Although such static rate-limits can prevent occurrence of the worst to a great degree, they however lead to sub-optimal resource usage. Embodiments of the present disclosure were developed in view of the above-described problems.

### SUMMARY

A technique is disclosed to track the resource usage of individual tenants in a multitenant platform. The tracking is performed at a granular request level. In some implementations, fingerprints are used to determine the resource usage of individual service requests. A variety of different use cases are supported.

An example of a computer-implemented method of monitoring and managing resource usage in a multi-tenant platform system, includes requesting multi-tenant access logs associated with tenant requests; tracking at least one metric of usage of a shared multi-tenant node resource; for each tenant service request, mapping attributes of the request to a fingerprint, where each fingerprint has a set of attributes and an associated resource usage of the shared multi-tenant resource; identifying usage of the shared multi-tenant node resource per service request of each tenant of the multi-tenant platform system; determining total tenant-specific usage of the shared multi-tenant resource in a selected time interval; and utilizing the monitored tenant-specific usage to perform at least one service for the multi-tenant platform system.

In one implementation, the request attributes comprise request type, request path, request payload size, and response time.

In one implementation, the tracking comprises tracking usage of at least one of a shared central processing unit (CPU), a shared memory, and API service requests to a third-party.

In one implementation, the tracking comprises tracking usage of at least one shared resource other than central processing unit (CPU) usage.

In one implementation, the tracking comprises tracking usage of at least one shared resource other than the shared memory.

In one implementation, the service comprises billing tenants, and the method comprises billing clients based on tenant-specific usage of the shared multi-tenant node resource.

In one implementation, the service comprises a noisy neighbor load balancing service and the method comprises throttling utilizing service request usage exceeding a usage limit. In one implementation, fingerprints are used to predict resource usage of service requests in process service requests of at least one tenant are throttled to be within a resource usage limit.

In one implementation, the service comprises reducing compute requirements and the method comprises, for a given load, matching higher CPU usage requests and lower CPU usage requests.

In one implementation, the service comprises utilizing predicted resource usage to select an efficient grouping for service requests within pre-selected limits.

In one implementation, the service comprises auto-scaling, and the method comprises performing auto-scaling based at least in part on load characteristics of incoming requests.

In one implementation, the service comprises capacity planning, and the method comprises utilizing the tenant specific usage and total usage to anticipate load patterns to schedule shared resources.

In one implementation, the service comprises determining resources consumed across all services consumed across all services for each tenant.

In one implementation, the service comprises production profile modeling.

In one implementation, the method includes apportioning usage of the shared multi-tenant resource to each tenant.

In one implementation, the fingerprints are static fingerprints configured by an administrator.

In one implementation, the fingerprints are dynamic fingerprints determined using an artificial intelligence flow.

In one implementation, the tenant requests include requests associated with reactive programming applications.

In one implementation, the tenant requests include requests associated with non-reactive programming applications.

### BRIEF DESCRIPTION OF THE DRAWINGS

FIG. 1 illustrates a system in accordance with an implementation of the disclosure.

FIG. 2 is a flowchart of a general method in accordance with an implementation of the disclosure.

FIG. 3 illustrates aspects of a method in accordance with an implementation of the disclosure.

FIG. 4 is a block diagram illustrating aspects of determining resource usage of different tenant requests in accordance with an implementation of the disclosure.

FIG. 5 is a diagram of a technique for smart load balancing of a noisy tenant in accordance with an implementation.

FIG. 6 is a flowchart of an example method for smart load balancing of a noisy tenant in accordance with an implementation.

FIG. 7 illustrates an example of a design flow for utilizing AI to aid in generating dynamic fingerprints in accordance with an implementation.

### DETAILED DESCRIPTION

### I. Overview

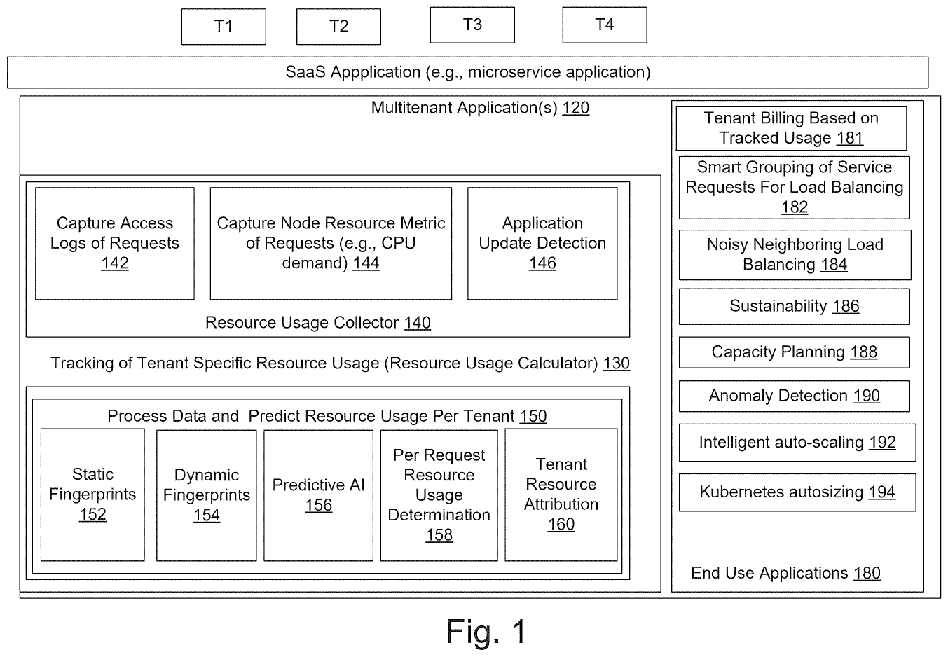

FIG. 1 is a high-level illustration of a multitenant system that tracks resource usage of tenants at a granular request level to address resource management problems in enterprise systems. The multi-tenant architecture of FIG. 1 is agnostic in the sense that it avoids the application-specific and technology specific issues of conventional usage tracking approaches.

A multitenant system supports a set of Tenants (e.g., T1, T2, T3, etc.), SaaS applications (e.g., microservice applications). In a multitenant platform, access logs are records of user activity within a system, typically including timestamps, user identities, and actions performed. In a multi-tenant architecture, a “node” typically refers to a single, physical or virtual server where the application runs. Multiple tenants share the same underlying hardware or cloud infrastructure. A node allows multiple tenants (users or organizations) to access the same software instance while keeping their data isolated from each other. A node is effectively a computing unit within the shared infrastructure that hosts and processes data for different tenants, ensuring each tenant's data remains separate through isolation mechanisms. In a cloud-based SaaS application, a single cloud server can act as a node where multiple tenants (e.g., customer companies) access their individual data with the same application.

In one implementation, a multitenant application layer 120 supports monitoring the use of shared resources. In one implementation, the multitenant layer 120 supports granular tracking of tenant specific resource usage 130. Examples of resource usage that are monitored may include CPU usage, memory usage, and usage of third-party API services (e.g., data input and output from third party database services). In one implementation, this is supported by a resource usage collector 140. The resource usage collector 140 in one implementation captures access logs of requests 142. In one implementation, it captures node resource metrics of requests 144 (e.g., CPU usage but more generally other types of resource usage, including memory usage and usage of third-party API services). Resource usage corresponds to the consumption of system resources by a tenant or application, such as CPU, memory, disk I/O, network bandwidth, etc. An application update detection module 146 may also be included to monitor updates.

A data processing module 150 processes the collected data and predicts resource usage per tenant and per service request. For example, an individual service request may be server request types such as GET and POST having specific request paths, payload size, and response time. In one implementation, static fingerprints 152 or dynamic fingerprints 154 are used to predict resource usage on a per-tenant, per request basis. In one implementation, fingerprints are used to determine predicted resource usage of incoming requests to facilitate prediction of resource consumption needs. An individual fingerprint associates shared resource usage metrics (e.g., CPU usage, memory usage, usage of their party API services, etc.), with a set of request attributes. This aids in using fingerprints to map request to resource usage.

Predictive artificial intelligence 156 may be used in a variety of different ways, including generating dynamic fingerprints 154. However, it will be understood that in some implementation other types of AI models, such as adaptive AI, may be used to generate dynamic fingerprints. Tenant resource attribution 160 is included to aid in determining resource usage per tenant. In one implementation, a system of linear equations is used to determine resource usage per tenant.

A variety of end use applications 180 may be supported by the granular tracking of resource usage. Some examples of end use applications include tenant billing based on tracked usage 181, smart grouping of service request for load balancing 182, noisy neighbor load balancing 184, sustainability 186, capacity planning 188, anomaly detection 190, intelligent auto-scaling 192, and container pods (e.g., Kubernetes) autosizing 194. Other examples of end use applications for optimization of message queue based on influx.

In the case of autosizing 194 container pods, it will be understood that pods are the smallest deployable units of computing that are creatable and manageable in a platform used to orchestrate (e.g., deploy, manage, and scale) containerized applications, with Kubernetes being one example of a platform to deploy, manage, and scale containerized applications. A pod is a group of one or more containers, with shared storage and network resources, and a specification for how to run the containers. In one implementation, optimal configuration (e.g., auto scaling out and scaling in) of pods is supported with respect to shared resources such as CPU and memory, by responding to real time traffic.

The system supports many possible use cases. It derives high-dimensional tenant specific metrics from low dimensional, low overhead observability signals. It provides a highly accurate determination of resource usage per service request for all types of requests from every tenant across all services. It provides a window into resources consumed by each tenant and by each tenant request type. It also provides a window into resources consumed across all services for each tenant. Many different multitenant platform problems can be solved using the granular resource tracking technique of the current applications.

TABLE 1
Table 1, below, illustrates some example problems that can be addressed.

| | Example Collected | Example Processed | |
|---|---|---|---|
| Technical Problem | Data | Data | Technical Solution Supported |
| Noisy neighbor on a SaaS | Access-logs | Calculate tenant | Enhance Load-balancer by |
| platform. | CPU usage data | specific usage | feeding it the predicted CPU |
| | per node | details | usage of all Fingerprints. |
| | | Dynamic | Load-balancer to predict the |
| | | Fingerprint of | CPU usage of every incoming |
| | | incoming requests | request and track CPU usage per |
| | | Predict the CPU | tenant for the last ‘n’ minutes. |
| | | usage of each | Load-balancer to check the |
| | | Fingerprint of | tenant-wise CPU usage limits and |
| | | requests and | throttle any tenant which is trying |
| | | summarize by | to consume more CPU than the |
| | | tenant | allotted limits. |
| | | Detect Noisy | |
| | | neighbor based on | |
| | | the above data. | |
| Tenant Resource Usage | Access-logs | | Throttle tenant level consumption |
| exceeds budgeted costs. | CPU usage data | | to ensure they don't exceed |
| | per node | | budgeted costs. |
| | | | Monitor Tenant level |
| | | | consumption to ensure they are |
| | | | within contractual limits. |
| Green computing / Efficient | Access-logs | Dynamic | Enhance Load balancer to adapt |
| usage of CPU resources | CPU usage data | Fingerprint of | to conditions on the nodes as well |
| | per node | incoming requests | as the CPU needs of the incoming |
| | | Predict the CPU | requests. |
| | | usage of each | Load balancer can intelligently |
| | | Fingerprint of | combine requests requiring high |
| | | requests | CPU with others that require low |
| | | | CPU to balance load more |
| | | | efficiently |
| | | | Intelligently mix and match high |
| | | | CPU requests with low CPU |
| | | | requests and thus reduce Compute |
| | | | requirements of the system for the |
| | | | same load |
| Intelligent Autoscaling | Access-logs | | Ability to scale out and scale in |
| characteristics. | CPU usage data | | nodes not just based on load |
| | per node | | characteristics of server nodes but |
| | | | also based on the incoming |
| | | | requests' load characteristics. |
| Capacity Planning | Access-logs | | Ability to anticipate load patterns |
| | CPU usage data | | and proactively schedule required |
| | per node | | resources. |
| Production resource | | | perform product resource |
| modelling | | | modeling predictions from only a |
| | | | few transactions created during |
| | | | design time or test time. |
| | | | Developer sets case volume by |
| | | | case type to see how planned |
| | | | growth impacts infrastructure size |
| | | | and cost. |
| Production resource | | | Production resource |
| consumption profile | | | consumption profile modelling |
| modelling | | | (without extensive performance |
| | | | and scalability testing) |
| | | | Virtual Monte Carlo simulation |
| | | | of production resources consumed |
| | | | as different aspects of the tenant |
| | | | application are adjusted such as |
| | | | one case type grows while another |
| | | | one stays relatively flat |
| Container pod (e.g., | Access-logs | | Finer grain resource |
| Kubernetes pod) auto sizing | CPU usage data | | management that reduces pod |
| costs when pods start to add | per node | | orchestration (e.g., Kubernetes) |
| more pods. | | | auto-sizing costs by maximizing |
| | | | available resources across all |
| | | | instances of a service before the |
| | | | pod orchestration starts to add |
| | | | more pods. |
| Effective Anomaly detection | CPU/Memory | Dynamic | The system sends a notification |
| (Proactively detect | usage data per node | fingerprint of | to the developers about a possible |
| regressions introduced by | Data from project | incoming requests | regression introduced by a new |
| application updates) | management tools | Analyze the | change that they recently |
| | about new feature | impact of changes | deployed. |
| | deployments | in attributes like | |
| | Access logs | application version | |
| | | and detect | |
| | | anomalies | |
| | | Correlate detected | |
| | | abnormalities to | |
| | | application updates | |

The granular tracking of tenant specific resource usage can be used for different purposes, such as tenant billing, load balancing, etc. In large scale/Enterprise multi-tenant systems, tracking resource usage of tenants and individual requests is extremely important because of their usefulness in solving many multitenant resource management problems.

In the context of multitenant billing, unless a tenant's resource usage is tracked properly, judicious billing is not possible. Under-charging a high-usage tenant or over-charging a low-usage tenant pose great risk to a SaaS platform's business. Granular tracking of tenant resource usage permits accurate billing of tenants based on their actual resource usage.

A noisy neighbor is a tenant that consumes excessive resources, impacting the performance of other tenants in a shared system.

Noisy neighbor issues arise when a tenant using high resources chokes out other tenants, starving other tenants for resources. Granular tracking of tenant resource usage supports dealing with the noisy neighbor problem for a SaaS platform.

Granular tracking of tenant resource usage in a multi-tenant SaaS platform also permits optimizations to intelligently optimize the order and sequence with which incoming requests are handled. For example, predicting resources usage for incoming requests permits requests with high CPU usage to be intelligently combined with requests with low CPU usage (or high memory, IO usage) and routed to a single node. This could minimize the number of nodes required to serve the same number of requests. This can also be described as falling into the category of Sustainability (or Green Computing).

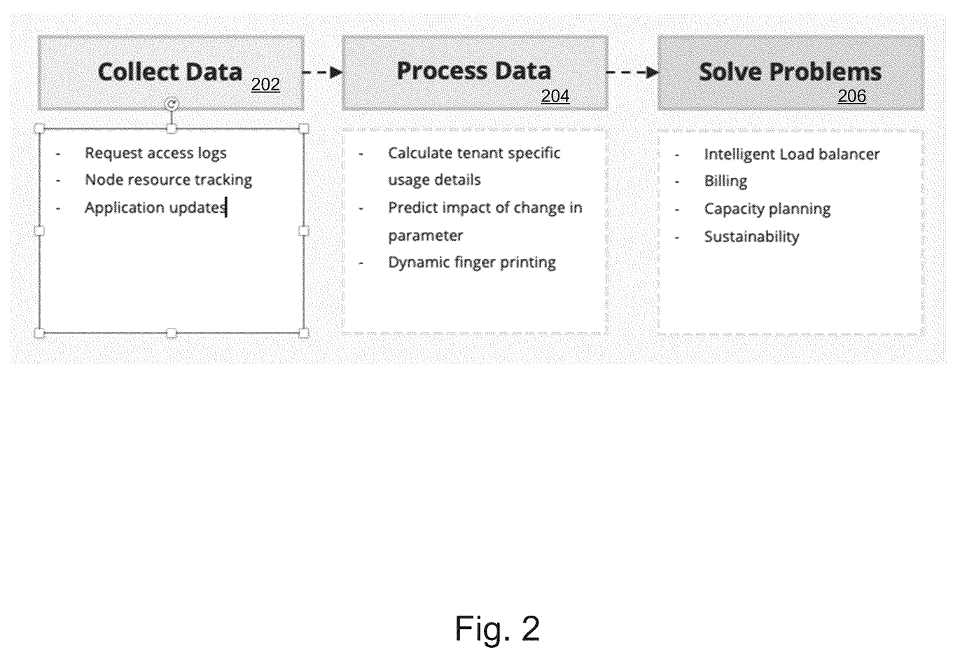

FIG. 2 is a high level flow chart of a 3-step process to perform granular resource tracking in accordance with an implementation.

In block 202, resource usage data is collected. This data collection in one implementation includes requesting access logs, node resource tracking (e.g., CPU usages, but more generally other usages of shared resources), and application updates.

In block 204, the data is processed to predict granular tenant-specific resource usage. This may include calculating tenant specific usage details. It may include predicting an impact of a change in a parameter. As discussed below in more detail, it may include dynamic finger printing.

In block 206, a variety of different problems may be solved by granular tracking of recourse usage, such as intelligent load balancing, billing, capacity planning, and sustainability.

The process illustrated in FIG. 2 is compatible with many different types of deployed software such as container pods (e.g., Kubernetes pods), virtual machines, Amazon Web Services (AWS) EC2 instances, physical servers, etc. For illustration purposes the examples below use Kubernetes pods and microservices based architecture. However, it will be understood by one in the art that the process may be used with a wide variety of different types of currently deployed software and future software releases.

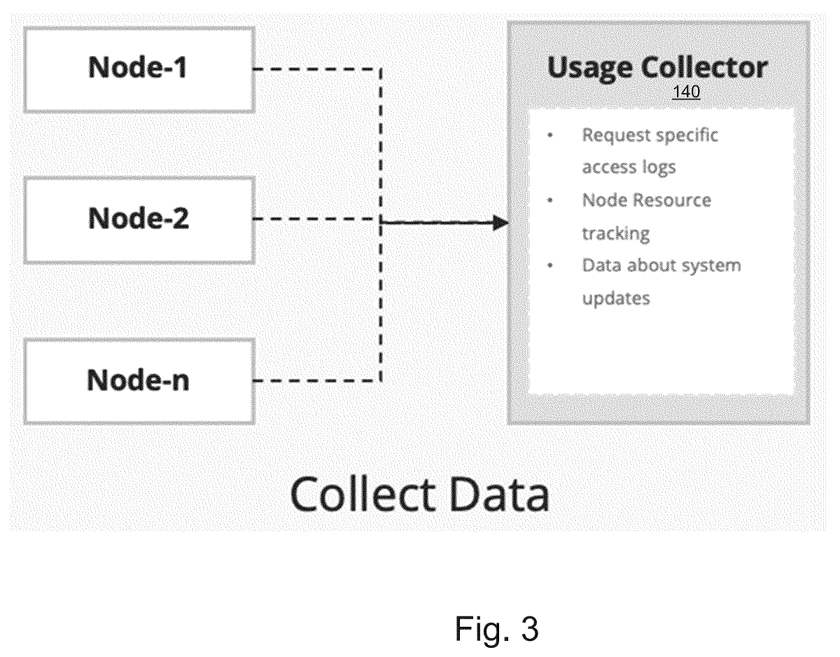

FIG. 3 illustrates aspects of the collect data block 202 of FIG. 2. In this step the process plugs in to sources which provide request specific telemetry, node specific telemetry and release management data etc. This may include requesting specific access logs, node resource tracking, and detecting/tracking data about system updates. For the purposes of illustration, an arbitrary positive integer number, n, of nodes is illustrated.

The process data step 204 of FIG. 2 processes the collected data (examples of which are elaborated later in this disclosure) and exposes APIs to aid in predicting answers for questions (e.g., to aid in solving problems in step 206). The solve problems step 206 includes new tools or enhancements of existing tools with ability to leverage APIs provided by step 204 and apply them to fulfil specific use cases.

### II. Fingerprint Matcher and Usage Calculator

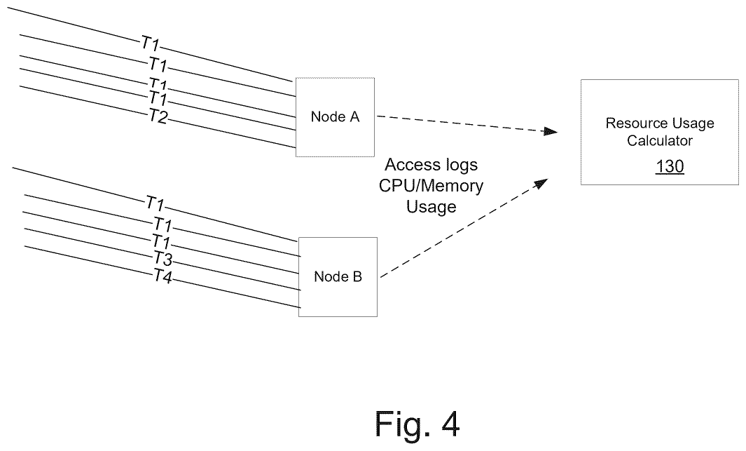

FIG. 4 illustrates an example in which there is a resource usage calculator. In one implementation, the resource usage calculator includes the intelligence to encapsulate the data usage collection and data processing function previously discussed. Each individual node has a set of requests from different tenants, which is illustrated by arrows T1, T 2, T3, T4. For example, at one moment in time, there may be different requests from each tenant to different nodes, such as Node A and Node B. The resource usage calculator predicts the resource usage of the different request and as discussed below in more detail; this information may be used to support a variety of different services.

In a distributed system, there are various tools that can be used to collect resource usage metrics, observability signals like access-logs, etc. All this data that is collected can be processed as previously discussed.

In one implementation, processing of collected resource data includes grouping service requests into different families of requests that have close/similar performance load (or resource requirements). In one implementation, each family of requests is termed as Fingerprint. A Fingerprint is a representation of a family of requests which have certain attributes in common.

Consider the following scenario where the resource usage calculator collected the following data for a given node in a time window.

TABLE 2
Example requests.

| | | Request | | |
|---|---|---|---|---|
| Request | | Payload | Response | Estimated |
| Type | Request Path | Size | Time | CPU usage |
| GET | /api/application/v2/cases/M-2343 | 95 KB | 48 ms | 50 m |
| POST | /api/application/v2/cases | 105 KB | 52 ms | 70 m |
| GET | /api/application/v2/assignments/P-235 | 82 KB | 46 ms | 20 m |
| GET | /api/application/v2/recents | 68 KB | 39 ms | 10 m |
| GET | /api/application/v2/cases/J-1234 | 115 KB | 58 ms | 50 m |
| GET | /api/application/v2/assignments/Q-789 | 87 KB | 48 ms | 20 m |
| POST | /api/application/v2/cases | 110 KB | 55 ms | 70 m |
| GET | /api/application/v2/recents | 72 KB | 42 ms | 10 m |
| POST | /api/application/v2/cases | 120 KB | 60 ms | 70 m |
| GET | /api/application/v2/cases/X-5678 | 100 KB | 50 ms | 50 m |
| GET | /api/application/v2/assignments/W-456 | 88 KB | 47 ms | 20 m |
| GET | /api/application/v2/recents | 78 KB | 43 ms | 10 m |
| POST | /api/application/v2/cases | 125 KB | 63 ms | 70 m |
| GET | /api/application/v2/cases/Y-9876 | 105 KB | 53 ms | 45 m |
| GET | /api/application/v2/assignments/Z-321 | 80 KB | 44 ms | 20 m |

In one implementation, the resource usage calculator would categorize the requests in Table 2 as the following Fingerprints in Table 3 based on attributes like performance characteristics, payload size, tenant-id, and request path etc. In this example, the fingerprints correspond to different estimate CPU usages, although more generally they could include estimated memory usages.

TABLE 3
Example set of fingerprints

| | | | Request | | Estimated |
|---|---|---|---|---|---|
| | Request | | Payload | Response | CPU |
| Fingerprint | Type | Request Path | Size | Time | usage |
| Finger- | GET | /api/application/v2/cases/M-2343 | 100 KB | 50 ms | 50 m |
| print-x | GET | /api/application/v2/cases/J-1234 | 120 KB | 60 ms | 50 m |
| | GET | /api/application/v2/cases/X-5678 | 110 KB | 55 ms | 50 m |
| | GET | /api/application/v2/cases/Y-9876 | 125 KB | 62 ms | 45 m |
| Finger- | GET | /api/application/v2/assignments/P- | 80 KB | 45 ms | 20 m |
| print-y | | 235 | | | |
| | GET | /api/application/v2/assignments/Q- | 85 KB | 47 ms | 20 m |
| | | 789 | | | |
| | GET | /api/application/v2/assignments/W- | 90 KB | 49 ms | 20 m |
| | | 456 | | | |
| | GET | /api/application/v2/assignments/Z- | 75 KB | 42 ms | 20 m |
| | | 321 | | | |
| Finger- | GET | /api/application/v2/recents | 70 KB | 40 ms | 10 m |
| print-z | GET | /api/application/v2/recents | 65 KB | 38 ms | 10 m |
| | GET | /api/application/v2/recents | 75 KB | 41 ms | 10 m |
| Finger- | POST | /api/application/v2/cases | 150 KB | 70 ms | 70 m |
| print-w | POST | /api/application/v2/cases | 130 KB | 65 ms | 70 m |
| | POST | /api/application/v2/cases | 140 KB | 75 ms | 70 m |

In the example of Table 3, the table may be used for mapping an incoming service request to an appropriate Fingerprint. This permits the resource consumption (e.g., CPU usage) to be estimated. That is, in some implementations, the Fingerprint of a request is based on a variety of considerations, including resource consumption. In some implementations, a Finger-printing algorithm estimates the resource usage (e.g., CPU usage) of any given request. As discussed below in more details, the share of resources used by a particular node may also be determined.

### II. Static Fingerprints

Several different fingerprint techniques may be used to estimate resource usage, such as CPU usage. In a static fingerprint implementation, all requests are grouped by request-path and request type. They may also be grouped by other attributes, such as similar response times and CPU usage. Thus, the static Fingerprints group the requests based on a static set of attributes such as request-path, request-type, response-time, etc. The set of static attributes may, for example, be identified by an administrator. As another example, a static set of attributes may be identified by an administrator using, for example, a user interface and heuristic tools to aid in selecting a static set of attributes.

Consider an example of a static fingerprint implementation. As an illustrative example, in one scenario, estimation of CPU can be done as follows. In each time window (say 1 minute, although more generally it could be a configurable time window) the usage calculator knows what requests are served by Node-A. For example, the access logs can give this information. The usage calculator in this example knows the aggregate CPU usage of Node-A. The node level CPU usage data can be analyzed to give this information in this sense of attributing, or apportioning, resource usage to different tenants. In one approach a system of linear equations is used.

As an illustrative example, suppose there are fingerprints fp1, fp2, and fp3 and suppose that x, y, z represents the CPU usage of Fingerprints fp1, fp2 and fp3 respectively, These three fingerprints can also be described as Fingerprint-x, Fingerprint-y, and Fingerprint-z.

Let k, l, m be the node level CPU usage consumed by the Node-A in these 3 time windows, respectively.

Suppose there were 2 requests of Fingerprint x and 1 request of Fingerprint-y. The aggregate CPU usage of these 3 requests is k units. Mathematically it can be represented as:

$$2 x + y = k$$

Similarly, we can have two more equations as below for two different time windows on the same node Node-A.

$$5 z + 10 y + 3 x = 1$$

$$3 y + 9 x = m$$

Solving the 3 equations above would give us the estimated CPU usage for each Fingerprint:

$$x = ( m - 3 k ) / 3 ; y = ( 3 k - 2 m ) / 3 ; z = ( 3 l - 7 k + 5 m ) / 5$$

Thus, for static fingerprints a linear equation may be used to determine the estimated CPU usage for each Fingerprint. A similar approach could be used to estimate memory usage for each Fingerprint.

In another implementation, the Fingerprints are dynamic. In one implementation, predictive AI is leveraged to estimate resource usage (e.g., CPU usage) for different fingerprints. Consider now an illustrative example of dynamic fingerprints. In this example, usage calculator knows all the requests served by a node during a time window and the resources (e.g., CPU resources) consumed by that node (say Node A) during that time window.

If there is only one request (say tenant-2, API1) served by Node A during a time window, then the Usage calculator would attribute all the CPU usage to that request. Thus, the profile of {tenant-2, API1} is determined by the usage calculator.

Thus, during times of low traffic many such reliable measurements can be captured by the usage calculator.

If there are two requests served by Node A ({tenant-2, API1} and {tenant-3 API1}), then based on the previous observations of the profiles of these requests, the usage calculator attributes the appropriate CPU usage to each of these requests.

Extending the same idea, in one implementation the usage calculator leverages Artificial Intelligence (AI) models, such as adaptive AI models or predictive AI models to estimate the CPU usage of different requests even when there are more than two requests served by node A during a time window. Ingestion of this data over a long enough period makes usage calculator more and more accurate.

### III. Example Use Case of Identifying Noisy Neighbor in a SaaS Platform

As an illustrative example, consider an end use case of estimating request and tenant specific CPU consumption details for identifying a noisy neighbor in a SaaS platform. A noisy neighbor is a tenant that generates an undue load on the SaaS Platform. Consider a SaaS platform which serves multiple tenants each of which has similar entitlements on the SaaS platform features. If one of the tenants is generating undue load on the platform which is in turn starving other tenants of their rightful share of the platform's resources, then the former is termed as a noisy neighbor.

For simplicity, consider an example in which CPU resources are the bottleneck, although more generally the issue of a noisy neighbor applies to memory and other resources consumption as well. A consideration is the availability of ways to measure the resource consumption at a node level. Capturing resource usage at a node level is possible with conventional tools, but it is impractical with conventional tools to capture it at a more granular level like the tenant level or the individual request level.

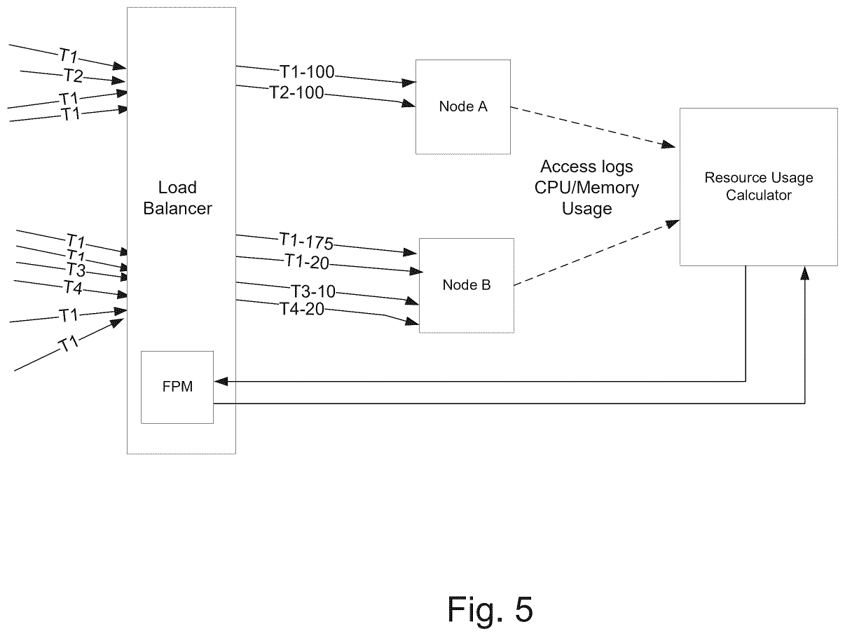

FIG. 5 illustrates a scenario, in which tenant T1 consumes most of the CPU resources in the SaaS platform and hence is the noisy neighbor for other tenants, such as tenants T2, T3, and T4.

In this example, as part of data collection, a mechanism is utilized to track the incoming requests and the resource usage of every node during each periodic interval, say ‘t’ seconds, where it is an arbitrary interval that in some implementations is configurable.

As an illustrative example, in one implementation, the resource usage calculator collects and processes the following kinds of data from all nodes:
1) Request access logs which include {request path, request method, tenant-id, request payload size, response payload size, request start time, response end time, etc.}
2) Node level CPU utilization metrics which include (CPU units consumed by the node in each time window, time-window-start-time, time-window-end-time)

The usage calculator then processes this data and aggregates the metrics at a tenant level for total processing time of requests, total request payload, and total response payload.

In this example, the ‘collector’ functionality in the usage calculator can be realized by leveraging existing observability tools.

In this example, the access logs may, as an example, include request type, request path, tenant type, request start time, and request end-time. A subset of details that can be derived from access logs is as follows:

TABLE 4

| | | | | | request |
|---|---|---|---|---|---|
| request | | | | request | end |
| type | request path | tenant | Type | start time | time |
| GET | /api/application/v2/cases/M-2343 | T4 | INBOUND | 11:05:03 | 11:05:10 |
| | | | | AM | AM |
| GET | /api/application/v2/assignments/P- | T3 | OUTBOUND | 11:05:06 | 11:05:08 |
| | 235 | | | AM | AM |
| GET | /api/application/v2/recents | T2 | INBOUND | 11:07:03 | 11:07:10 |
| | | | | AM | AM |
| POST | /api/application/v2/cases | T1 | INBOUND | 11:07:08 | 11:07:12 |
| | | | | AM | AM |

Table 4 illustrates request types, request paths, tenant, and other information can be acquired from access logs.

The node level CPU usage may be specified in terms of node-id, start time, end time, and CPU used (in terms of a metric of CPU usage). As an example, the node level CPU usage captured would be of the format:

TABLE 5

| node-id | start-time | end-time | CPU used |
|---|---|---|---|
| Node-A | 11:05:05 | 11:06:05 | 100 |
| Node-B | 11:05:05 | 11:06:05 | 100 |
| Node-A | 11:06:05 | 11:07:05 | 100 |
| Node-B | 11:06:05 | 11:07:05 | 100 |

In this example, the data collected by the usage calculator is not sufficient by itself to estimate the CPU usage of each tenant. This is because in a multi-tenant SaaS platform all the resources are shared with all the tenants for optimal resource consumption. The resource usage (CPU in this case) of a node must be attributed appropriately to the different tenants that used that node during a specific time slot.

FIG. 5 illustrates a specific example of identifying a noisy neighbor and throttling its load in near real-time using a fingerprint matcher (FPM) to enhance the operation of a load balancer. The CPU usage is tracked and estimated at the granularity of individual requests. Incoming service request are mapped to a fingerprint to estimate its CPU usage. The CPU usage per tenant is tracked based on the above estimation.

For a given request, a determination is made of the Fingerprint it belongs to, and hence what is the CPU units it might consume. For example, a determination may be made in the last ‘n’ minutes (where n is configurable) of the aggregate CPU units consumed by a specific tenant. A determination can be made of the percentage of the CPU units used by a specific tenant in relation to the CPU used by all the tenants together. Moreover, a comparison can be made to the permissible limits for that tenant as defined by a business contract. This information can be used to determine if there are any potential noisy neighbors on the platform.

In one implementation, the resource usage calculator defines resource limits dynamically based on the number of tenants using the platform and available resources (CPU in this scenario).

FIG. 5 illustrates an example of a load balancer that allows only requests that sum up to the permissible CPU limits or less for any tenant. In this example, each request has a tenant associated with it (e.g., T1, T2, T3, T4) and also a unit metric of a resource usage (e.g., 10, 20, 100, 175). Various constraints can be applied, such as tenant T1 having request throttled to consume a maximum limit of 300 CPU units. For example, tenants T1 and T2 may be assigned a permissible CPU resource limit of 300 units. Tenant T3 may be assigned a permissible CPU limit of 100 units, and tenant T4 may be assigned a permissible CPU limit of 150 units.

Some sample values of resources assigned to several different tenant requests are illustrated. In one implementation, the CPU usage is fetched per fingerprint and the permitted CPU limits for each tenant are considered. In one implementation, there is an asynchronous fetch between the usage calculator and a fingerprint matcher (FPM). The asynchronous fetching may, for example, occur approximately every minute (or on some other basis). In this example, the Load balancer is enhanced to fetch the following data: 1) Fingerprints and their estimated CPU usage; and 2) permitted CPU units a tenant can consume (e.g., in a specified time interval, such as 5 minutes). Equipped with this data, the load balancer can track all the requests it is serving in (e.g., in the last 5 minutes), calculate estimated CPU usage of each tenant and if any tenant is crossing the ‘permitted CPU limit’, throttle that tenant's requests.

It will be understood that in alternate implementation, monitoring tools can be configured to periodically check with resource usage calculator for any potential noisy neighbors based on data.

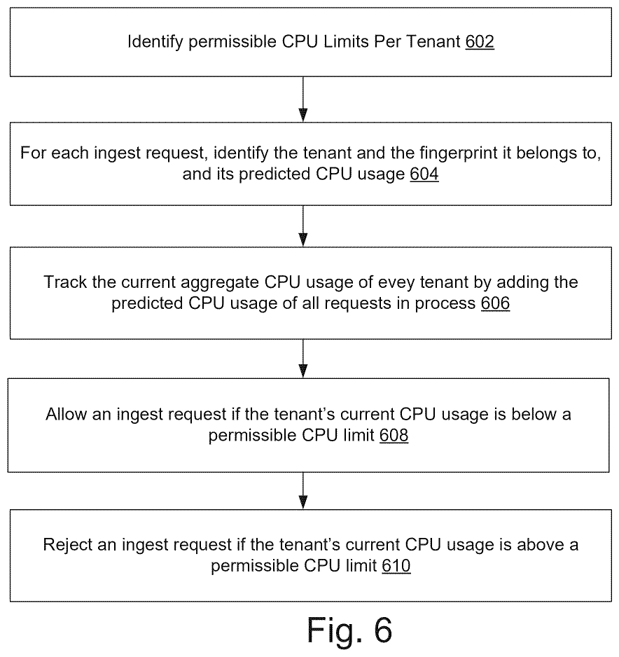

FIG. 6 is a flow chart of an example method. In block 602, permissible CPU limits per tenant are identified. For example, an administrator may set the permissible CPU limits per tenant. In block 604, for each ingest request, the method identifies the tenant and the fingerprint it belongs to, as well as its predicted CPU usage. In block 606 the method tracks the current aggregate CPU usage of every tenant by adding the predicted CPU usage of all requests in process. In block 608, an ingest request is allowed if the tenant's current CPU usage is below a permissible CPU limit. In block 610, an ingest request is rejected if the tenant's current CPU usage is above a permissible CPU limit.

### IV Example Architecture and Design for Dynamic Fingerprint Method

A variety of different AI architectures may be used to determine dynamic fingerprints. It will be understood that a variety of different AI models known in the artificial intelligence field may be used to determine dynamic fingerprints, including predictive and adaptive AI models.

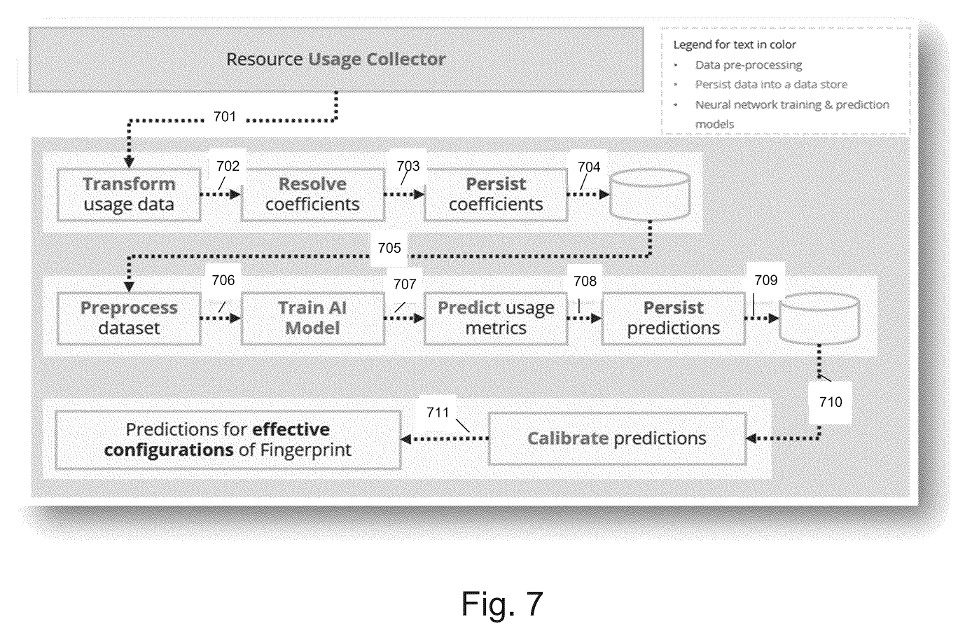

FIG. 7 illustrates an example of a predictive AI implementation to determine dynamic fingerprints. In one implementation, the resource usage collector 700 collects resource utilization of service requests on a given node or tenant such as node name, CPU identity, timestamp, total CPU periods, CPU periodic delta, and total CPU throttled periods. Similar data extraction should be deployed for memory, network, io resource utilization.

An example of a design flow associated with an AI method is as follows. The Resource usage collector disseminates 701 consumption metrics of various service requests for every ‘x’ minute(s) in time. This can include, for example, CPU usage, memory usage, etc.

“Transform usage data block” converts 702 the dataset into a matrix of linear equations. In one implementation, raw data is transformed into linear equations with first degree coefficients for an interval of time. In the Resolve Coefficient block, the method resolves coefficients 703 using Operations Research techniques and persists the coefficients 704 into a data store. The method in one implementation progressively accumulates data in chunks 705 that are fed into the Preprocess block to generate preprocessed data 706 to inspect and treat anomalies & outliers. The dataset is split to train, validate and test datasets used to train 707 the AI model and predict usage metric 708 and persist the predicted usage metric 709 into a data store.

In one implementation, the method asynchronously repeats the steps of collecting, pre-processing, and predicting the resource consumption of service types considering its interdependencies. In one implementation, this is a parallel process for various resource type such as CPU, memory, network traffic, data input & output, etc.

In implementation, the persisted predicted data 710 is accumulated and will eventually go through a prediction calibration 711 for effective configuration of Fingerprints and is progressively updated after every calibration step to generate prediction for effective configuration of fingerprints.

As an example of some aspects of the transform usage data block 702, in one implementation a method is utilized that transforms a set of linear equations with first degree coefficients for an interval of time. A general example of the linear equations is provided below for resource usage, which may include, for example, CPU usage, memory usage, and network data traffic.

| | | |
|---|---|---|
| x₁r₁ + x₂r₂ + x₃r₃ + . . . + xₙrₙ = | x₁r₁ + x₂r₂ + x₃r₃ + . . . + xₙrₙ = | x₁r₁ + x₂r₂ + x₃r₃ + . . . + xₙrₙ = |
| x cpu used | x mem used | x_networkdata_traffic |
| y₁r₁ + y₂r₂ + y₃r₃ + . . . + yₙrₙ = | y₁r₁ + y₂r₂ + y₃r₃ + . . . + yₙrₙ = | y₁r₁ + y₂r₂ + y₃r₃ + . . . + yₙrₙ = |
| y cpu used | y mem used | y_networkdata_traffic |
| p₁r₁ + p₂r₂ + p₃r₃ + . . . + pₙrₙ = | p₁r₁ + p₂r₂ + p₃r₃ + . . . + pₙrₙ = | p₁r₁ + p₂r₂ + p₃r₃ + . . . + pₙrₙ = |
| p cpu used | p mem used | p_networkdata_traffic |

### Example Set of Linear Equations

As an example, consider the example data set of Table 6 below, modified for human readability, in which there is a set of tenants (e.g., tenant-red, tenant-orange, tenant-blue, and tenant-green), a shared resource (e.g., CPU usage); observations over two different time ranges, a resource usage factor for each service request (e.g., in Table 6 an example set of resource usage factors for servicing the example set of services is 50, 80, 83.33, 100, 50, 50, 100, 100), and optionally other data (e.g., CPU periodic delta).

TABLE 6
Example Data Set

| | | Container | | | | |
|---|---|---|---|---|---|---|
| | | CPU Sfs | | | | |
| | | Periodic | | | | |
| Observation | Time Range | Delta | ReqObs | Tenant | Factor | |
| CPU-1 | 9:56:53-9:57:08 | 140 | Service-4 | Red | 50.00 | 4 of the 8 ms fit |
| | | | | | | within timeframe |
| CPU-1 | 9:56:53-9:57:08 | 140 | Service-5 | Red | 80.00 | 8 of the 10 ms fit |
| | | | | | | within timeframe |
| CPU-1 | 9:56:53-9:57:08 | 140 | Service-6 | Orange | 83.33 | 5 of the 6 ms fit |
| | | | | | | within timeframe |
| CPU-1 | 9:56:53-9:57:08 | 140 | Service-7 | Blue | 100.00 | |
| CPU-1 | 9:56:53-9:57:08 | 140 | Service-8 | Blue | 50.00 | 4 of the 8 ms fit |
| | | | | | | within timeframe |
| CPU-2 | 9:57:08-9:57:23 | 155 | Service-8 | Blue | 50.00 | 4 of the 8 ms fit |
| | | | | | | within timeframe |
| CPU-2 | 9:57:08-9:57:23 | 155 | Service-9 | Orange | 100.00 | |
| CPU-2 | 9:57:08-9:57:23 | 155 | Service-10 | Green | 100.00 | |

As an example, consider the coefficients x1, y1, p1 are the number of service requests of type r1. The Example Set of Linear Equations would reflect the factors of Table 6 as follows:

$$50 r 4 + 80 r 5 + 83 r 6 + 100 r 7 + 50 r 8 = 140 for a time range of 09 : 56 : 53 to 09 : 57 : 23 on CPU - 1$$

$$50 r 8 + 100 r 9 + 100 r 10 = 155 for a time range of 09 : 57 : 08 to 09 : 57 : 23 on CPU - 2$$

These equations will be referred hereafter as EQ-1

In one implementation, for the resolve, persist coefficients and preprocess aspects, the system combines multiple equations of type EQ-1, and feeds input linear equation resolver using Operations Research techniques. In this example, the resolution determines the value of r1, r2, r3, . . . rn. and will be persisted into a data store by “Persist coefficients” component.

In one implementation for the training of the AI model, the qualified dataset will undergo a process of splitting for training, validation, and test phases before marking it a version of AI model. In one implementation, the AI model is developed using LSTM (Long Short-Term Memory) model of type deep learning recurrent neural network method, is an algorithm for time-series predictions and forecasting datasets. The Following are few design aspects for higher prediction accuracy:
1) Configure neural network model with multi-layer perceptron with a supervised learning process, to achieve an intended outcome. This includes resource consuming of resources shared among multiple service requests at a given time interval.
2) Configure the neural network with back propagation to learn complex patterns while iterating through the neurons for effective error adjustment by tuning of weights and bias.
3) Leverage hyper-parameterization to enhance the model, and tune parameters such as learning rate, number of hidden layers, batch size, epochs, etc.
4) Achieve an evaluation metric value, root mean squared error (RMSE) at <0.5 for optimal and <0.75 for good accuracy.

In one implementation, the AI model is a multi-layer perceptron neural network. In one implementation, the AI model provides predictions for following 2 key scenarios where features are enhanced across releases and its resource utilization may also vary:

Consider that the functional features Request-A is represented as Ra, Request-B (Rb), Request-C (Rc) and Request-N (Rn)

Scenario-1: Ra was enhanced in application release v1 would be referred as Ra1 while other features Rb, Rc . . . Rn may or may not have enhanced. This model considers Ra as base version and Ra1 would be an enhanced version. The system predictions for both Ra and Ra1 separately are considered as 2 distinct request types.

Scenario-2: Across multiple releases of an application, Ra hasn't enhanced whereas one or more in Rb, Rc . . . Rn are enhanced. System continues to predict Ra across application release versions and should be considered for resource configurations. As per design: Ra predictions are calibrated with reference to influence of resources consumed by other requests Rb, Rc . . . Rn. Therefore, Ra predictions across releases (though not enhanced) may or may not vary.

### Reactive Programming and Non-Reactive Programming Applications

It will be understood that the previously described techniques for tracking multitenant platform architecture are versatile and that while they can be applied to granular monitoring of resource usage of reactive programming applications, they can be applied to non-reactive programming applications, and to cases in which there are both reactive programming applications and non-reactive programming applications.

### Glossary

Multi-tenant system: A software application or system that serves multiple customers (tenants) with distinct data and configuration settings.

Resource usage: The consumption of system resources by a tenant or application, such as CPU, memory, disk I/O, network bandwidth, etc.

Instrumentation: The process of adding code or tools to a software application to measure and monitor its behavior.

Reactive programming: A programming paradigm that focuses on data streams and the propagation of change

Observability: The ability to understand the internal state of a system based on its outputs.

Access logs: Records of user activity within a system, typically including timestamps, user identities, and actions performed.

OS process metrics: Performance data collected from the operating system about running processes, such as CPU usage, memory consumption, and disk I/O.

### Alternate Technical Implementations

It will be understood that some aspects of a system may be implemented in software while other aspects may be implemented in hardware. An overall multitenant solution is supported by computer processors, memory, and other hardware components, which may vary depending on technical implementation details.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. The disclosed technologies can take the form of an entirely hardware implementation, an entirely software implementation or an implementation containing both software and hardware elements. In some implementations, the technology is implemented in software, which includes, but is not limited to, firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A computer-implemented method of monitoring and managing resource usage in a multi-tenant platform system, comprising:
requesting multi-tenant access logs associated with tenant requests;
tracking at least one metric of usage of a shared multi-tenant node resource;
for each tenant service request, mapping attributes of the request to a fingerprint, where each fingerprint has a set of attributes and an associated resource usage of the shared multi-tenant resource;
identifying usage of the shared multi-tenant node resource per service request of each tenant of the multi-tenant platform system;
determining total tenant-specific usage of the shared multi-tenant resource in a selected time interval; and
utilizing the monitored tenant-specific usage to perform at least one service for the multi-tenant platform system.

2. The method of claim 1, wherein the request attributes comprise request type, request path, request payload size, and response time.

3. The method of claim 1, wherein the tracking comprises tracking usage of at least one of a shared central processing unit (CPU), a shared memory, and API service requests to a third-party.

4. The method of claim 1, wherein the tracking comprises tracking usage of at least one shared resource other than central processing unit (CPU) usage.

5. The method of claim 1, wherein the tracking comprises tracking usage of at least one shared resource other than the shared memory.

6. The method of claim 1, wherein the service comprises billing tenants, and the method comprises billing clients based on tenant-specific usage of the shared multi-tenant node resource.

7. The method of claim 1, wherein the service comprises a noisy neighbor load balancing service and the method comprises throttling utilizing service request usage exceeding a usage limit.

8. The method of claim 3, comprising:
utilizing fingerprints to predict resource usage of service requests in process; and
throttling service requests of at least one tenant to be within a resource usage limit.

9. The method of claim 1, wherein the service comprises reducing compute requirements and the method comprises, for a given load, matching higher CPU usage requests and lower CPU usage requests.

10. The method of claim 8, further comprising using predicted resource usage to select an efficient grouping for serving requests within pre-selected limits.

11. The method of claim 1, wherein the service comprises auto-scaling, and the method comprises performing auto-scaling based at least in part on load characteristics of incoming requests.

12. The method of claim 1, wherein the service comprises capacity planning, and the method comprises utilizing the tenant specific usage and total usage to anticipate load patterns to schedule shared resources.

13. The method of claim 1, wherein the service comprises determining resources consumed across all services consumed across all services for each tenant.

14. The method of claim 1, wherein the service comprises production profile modeling.

15. The method of claim 1, further comprising apportioning usage of the shared multi-tenant resource to each tenant.

16. The method of claim 1, wherein the fingerprints are static fingerprints configured by an administrator.

17. The method of claim 1, wherein the fingerprints are dynamic fingerprints determined using an artificial intelligence flow.

18. The method of claim 1, wherein at least the tenant requests include tenant requests associated with reactive programming applications.

19. The method of claim 1, wherein at least some tenant requests include tenant requests associated with non-reactive programming applications.

20. A computer-implemented method of monitoring and managing resource usage in a multi-tenant platform system, comprising:
requesting multi-tenant access logs associated with tenant requests;
monitoring usage of at least one shared multi-tenant node resource;
for each tenant service request, mapping attributes of the request to a fingerprint, where each fingerprint has a set of attributes and an associated resource usage of the at least one shared multi-tenant resource;
identifying usage of the at least one shared multi-tenant node resource per service request of each tenant of the multi-tenant platform system;
determining total tenant-specific usage of the at least one shared multi-tenant resource in a selected time interval;
wherein tenant specific metrics are generated from low-overhead observability signals.

21. The method of claim 20, further comprising determining shared resources consumed across all shared services for each tenant.

22. The method of claim 20, further comprising determining shared resources consumed by each tenant and by each tenant request type.
